(19) United States
(12) Patent Application Publication
(10) Pub. No.: US 2025/0095054 A1
(43) Pub. Date: Mar. 20, 2025

(54) SYSTEM AND METHOD FOR FACILITATING THE PURCHASE OF ITEMS IN AN ONLINE ENVIRONMENT

(71) Applicant: SMARTIPANTS MEDIA PTY LTD, St Ives (AU)

(72) Inventors: Clinton DICK, St Ives (AU); Summer JAMES, St Ives (AU); Louise JAMES, St Ives (AU)

(21) Appl. No.: 18/294,187

(22) PCT Filed: Aug. 2, 2022
(86) PCT No.: PCT/AU2022/050824

§ 371 Date: Feb. 1, 2024

(30) Foreign Application Priority Data
Aug. 2, 2021 (AU) 2021902385

(51) Int. Cl. G06Q 30/0601; G06T 19/00

(52) U.S. Cl. CPC G06Q 30/0643; G06Q 30/0627; G06T 19/00

(57) ABSTRACT

A computer-implemented system and method for facilitating the identification, selection and purchase of wearable items in an online environment by consumers. In particular, the present invention provides a system and method that assists a consumer to identify clothing, headgear and/or footwear of appropriate size as compared with their own physical measurements and/or preferences, thereby increasing the likelihood of users purchasing clothing, headgear and/or footwear items online that represent items of suitable size or a “good fit” according to the size of the various body parts of the consumer and according to their preferences regarding fit.

### CROSS-REFERENCE TO RELATED APPLICATIONS

This is a national phase of PCT Application PCT/AU2022/050824, filed on Aug. 2, 2022, which claims priority to Australian Patent Application AU 2021902385, filed on Aug. 2, 2021, the entire contents of each of which are incorporated herein by reference.

### FIELD OF THE INVENTION

The present invention relates to a system and method for facilitating the identification, selection and purchase of items in an online environment by consumers. In particular, the present invention provides a system and method that assists a consumer to identify clothing, headgear and/or footwear of appropriate size to best accommodate their own physical measurements and/or fitment preferences, thereby increasing the likelihood of users purchasing clothing, headgear and/or footwear items online that represent items of suitable size or a “good fit” according to the size of the various body parts of the consumer and according to their preferences.

### BACKGROUND OF THE INVENTION

The emerging popularity of the internet over the past decade has changed how consumers purchase items, and online shopping (e-commerce) has become an important part of the global retail industry. Online shopping is predicted to experience continued growth as consumers seek the convenience of online shopping and the competitive pricing of online goods. Other factors contributing to the continued growth of the e-commence industry include an expanding range of products that are available online, the recent Covid-19 pandemic, faster internet speeds, more accessible internet and increased online transaction security.

However, despite the convenience associated with online shopping, many consumers experience confusion and frustration when receiving items purchased online, particularly with respect to items that require a specific sizing/dimension in order to be fit for purpose and which can be unsuitable despite the consumer ordering what was considered to be the correct size. In particular, items such as clothing, headgear and footwear typically have high rates of return due to incorrect sizing and/or a poor/uncomfortable fit that primarily arises due to variations in “standard” sizing between manufacturers and/or jurisdictions. For example, a size 10 dress in the United States may not necessarily be the same size as compared with a size 10 dress in Australia. Accordingly, a consumer in Australia who would normally purchase a size 10 dress according to Australian sizing standards, may actually be a size 6 according to US sizing standards. Additionally, sizing differs across all European countries.

Furthermore, although many consumers order items online that may be the correct dimension (size) in one aspect (for example, a size 8 shoe), the item may be a poor fit due to a narrow width as a result of the particular style of footwear and/or the particular manufacturer. This necessitates the consumer exchanging the item for an item of an alternative style/size or requesting return of their money with both options requiring the consumer to send the purchased item back to the online retailer.

Although most online retailers allow the return of items according to ‘change of mind’ policies, frustration experienced with the receipt of incorrectly sized and/or poor fitting items tends to cause consumers to avoid online shopping for clothing and footwear which results in reduced sales revenue for online retailers. Furthermore, returning items results in a waste of the consumer's time since the consumer is not only required to wait for an initial order to be processed, packaged and delivered, but is further inconvenienced if required to return their purchased item and await receipt of any alternative replacement item. Similarly, the returning of items wastes time and resources on the part of the retailer and is therefore also undesirable from a retailer perspective.

Returning unsuitable items also increases vehicle traffic (associated with pick-up and delivery of returned or re-ordered items) and wastes resources associated with the need to re-package and return such items. For example, the return of unsuitable items results in the wastage of packaging materials and fuel which has a negative impact upon the environment, particularly when considering e-commence is carried out on a global scale. Returning unsuitable items also results in increased internet traffic and a wastage of computing resources including processing, memory and data communication resources associated with increased online communications between consumers and online retailers when clarifying the nature of the return and/or effecting and confirming the return.

Furthermore, an increase in the rate of return of items purchased online increases the pressure placed upon delivery service providers as a result of longer delivery times and sub-optimal performance. Ultimately, all of these problems reduce consumer confidence with respect to shopping online and ultimately persuades many consumers to avoid online shopping, particularly for items such as clothing and footwear.

Accordingly, there exists a need for a system and method that enables individuals to readily identify and purchase clothing and footwear online that increases the prospects of a “good fit”. This would be expected to conserve computing resources and reduce the rate of returned items and thereby avoid frustration experienced by consumers, online retailers and delivery service providers. Reducing the rate of return of items purchased online will also avoid wasting fuel associated with delivery and return of such items by road, sea and air, and also avoid wasting packaging, thereby reducing the negative impact of such wastage of resources on the environment.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented system for facilitating the purchase of wearable items in an online environment, the system including an image capture facility operable to obtain multiple optical images of a body part of an individual along with an object of known dimensions that is attached to, or located in proximity with, the body part and thereby also in view of the image capture facility, and resolving, by an optical resolution technique, the images to generate a three-dimensional model of the body part, wherein the resolving of optical images to generate the three-dimensional model includes comparison of the body part images with the object of known dimensions to further provide relative and/or absolute sizing information regarding the three-dimensional model of the body part, one or more processors operable to receive input data from one or more retailers offering a range of wearable items for purchase, the input data including detailed dimensions of the wearable items, one or more databases in communication with the one or more processors, the one or more databases configured to store the physical dimensions of the body part, as determined from the sizing information provided by the three-dimensional model, a searching facility configured to identify one or more wearable items of interest in the range of wearable items offered for purchase that include detailed dimensions similar to the physical dimensions of the body part as determined from the sizing information provided by the three dimensional model, according to a similarity threshold, the one or more processors further operable to generate and provide a display of the one or more wearable items of interest that include based on the similarity threshold, similar detailed dimensions as compared with the physical dimensions of the body part according to the sizing information provided by the three-dimensional model of the body part.

In an embodiment, the individual utilizes a software application operable on a data communications device to access the searching facility.

In an embodiment, the body part of the individual is a body part, a combination of body parts, a body region or regions, or an entire body of the individual. For example, the individual may be required to capture multiple optical images of a particular body part or region in some circumstances, such as the individual's waist region, whereas in other circumstances, it may be necessary for the individual to capture images of a larger region or the entire body to enable relevant physical dimensions to be determined. Irrespective of the body part or region, multiple optical images are obtained to generate a three-dimensional model of the body part.

In an embodiment, obtaining optical images of the body part of the individual includes utilizing an optical hardware component associated with a mobile data communications device, including passing an optical lens associated with the optical hardware component over the body part. For example, a camera associated with a smartphone of the individual is capable of capturing images of a body part (or parts) of the individual.

In an alternative embodiment, obtaining optical images of the body part of the individual includes utilizing fixed body image capture hardware associated with a retailer which is configured to capture the multiple optical images.

In an embodiment, the optical images of the body part are captured from a range of different angles to enable generation of the three-dimensional model.

[THIS PARAGRAPH INTENTIONALLY LEFT BLANK]

In an embodiment, the one or more operations further include providing guidance regarding adequate capture of body part images, and audible and/or visual prompts to guide the individual when capturing images including when they have attained sufficient images to enable generation of the three-dimensional model of the body part with sufficient data to determine the dimensions of features in the model.

In an embodiment, in addition to determining the physical dimensions of the body part based on multiple received images, one or more dimensions may be determined subsequent to generation of a three-dimensional model. The resolution of the images to determine the three-dimensional model is assisted by data input by the individual. For example, the individual may be prompted by the software application to manually enter one or more physical dimensions of the body part that was unable to be determined from the resolution of images and generation of the model.

In an embodiment, the software application is operable to generate a display of the physical dimensions and/or the three-dimensional model of the body part.

In an embodiment, the generated display of the one or more wearable items of interest that include similar detailed dimensions as compared with the physical dimensions of the body part includes a scrollable listing of items.

In an embodiment, the one or more processors are further operable to delete any received optical image(s) once the physical dimensions of the body part have been determined from the three-dimensional model.

In an embodiment, the software application is operable to prompt the individual to provide an updated series of optical images of the body part for the purpose of ensuring that the stored physical dimensions of the body part are accurate and hence substantially representative of current physical dimensions of the body part.

In an embodiment, the searching facility enables the individual to filter the displayed one or more items of interest, according to any one or more of:
a name of the item,
a category of the item,
a brand name associated with the item,
a location or geographical zone,
a retailer of the item,
a price of the item,
a visual attribute of the item (e.g. colour, style), or
a physical attribute (e.g. material).

In an embodiment, the display of the one or more wearable items of interest is limited to only those wearable items that include similar detailed dimensions as compared with the physical dimensions of the body part according to the similarity threshold, hence avoiding further requirement for the individual to review and filter results to ensure that the displayed wearable items will represent a substantially correct and/or preferred fit.

In an embodiment, the similarity threshold is selected based upon the particular body part and/or item under comparison.

In an embodiment, in the event there are no results in the display of the one or more wearable items of interest on the basis that there are no wearable items located which have similar detailed dimensions as compared with the physical dimensions of the body part according to the similarity threshold, the one or more processors are further operable to generate a prompt to the individual to broaden their search so that the listing includes wearable items of the nearest size.

In an embodiment, the wearable item is an item of clothing, footwear or headgear.

In an embodiment, selection of a particular item in the display of the one or more wearable items of interest causes the software application to perform an action including any one or more of:
generating one or more user interfaces that provide additional information relating to the selected wearable item,
generating one or more user interfaces that display the three-dimensional model of the body part including graphical representations of the selected wearable item worn by the three-dimensional model of the body part;
generating one or more user interfaces enabling purchase of the selected wearable item; or
operating a web browser to display a page associated with a retailer of the wearable item to thereby enable purchase of the wearable item from the retailer's online store.

In an embodiment, item retailers may also access the software application for the purpose of uploading and managing details relating to the wearable items that the retailer offers for purchase, the details including the detailed dimensions of the wearable item in each available size, and further including one or more of an image of the wearable item, item stock, or links to the retailer website and/or online store.

In an embodiment, the stored input data relating to each wearable item regularly synchronizes with one or more computer systems associated with the retailer to ensure that the stored input data is maintained up to date.

In an embodiment, functionality associated with the software application is integrated into a retailer's online store using an application programming interface (API), such that when the individual accesses the online store and views and/or searches wearable items of interest, only those wearable items of interest that include similar detailed dimensions as compared with the physical dimensions of the body part of the individual will be displayed and/or listed in search results generated from the online store.

In another aspect, the present invention provides a computer-implemented method for facilitating the purchase of wearable items in an online environment, the method including obtaining, using an image capture facility, multiple optical images of a body part of an individual along with an object of known dimensions that is attached to, or located in proximity with, the body part and thereby also in view of the image capture facility and resolving, by an optical resolution technique, the images to generate a three dimensional model of the body part, wherein the resolving of optical images to generate the three-dimensional model includes comparison of the body part images with the object of known dimensions to further provide relative and/or absolute sizing information regarding the three dimensional model of the body part, receiving, by one or more processors, input data from one or more retailers offering a range of wearable items for purchase, the input data including detailed dimensions of the wearable items, storing, by one or more processors, the physical dimensions of the body part, as determined from the sizing information provided by the three-dimensional model, searching for and identifying, by a searching facility, one or more wearable items of interest in the range of wearable items offered for purchase that include similar detailed dimensions as compared with the physical dimensions of the body part as determined from the sizing information provided by the three dimensional model, according to a similarity threshold, and generating and providing, by one or more processors, a display of the one or more wearable items of interest that include based on the similarity threshold, similar detailed dimensions as compared with the physical dimensions of the body part according to the sizing information provided by the three-dimensional model of the body part.

In another aspect, the present invention provides a computer-readable medium having a plurality of computer instructions executable by one or more processors, that, when executed, cause the one or more processors to perform the steps of obtain using an image capture facility, multiple optical images of a body part of an individual along with an object of known dimensions that is attached to, or located in proximity with, the body part and thereby also in view of the image capture facility, and resolving, by an optical resolution technique, the images to generate a three-dimensional model of the body part, wherein the resolving of optical images to generate the three-dimensional model includes comparison of the body part images with the object of known dimensions to provide relative and/or absolute sizing information regarding the three dimensional model of the body part, receive input data from one or more retailers offering a range of wearable items for purchase, the input data including detailed dimensions of the items, store, in one or more databases, the physical dimensions of the body part, as determined from the sizing information provided by the three-dimensional model, searching for and identifying, by a searching facility, one or more wearable items of interest in the range of wearable items offered for purchase that include similar detailed dimensions as compared with the physical dimensions of the body part as determined from the sizing information provided by the three-dimensional model, according to a similarity threshold, and generating and providing a display of the one or more wearable items of interest that include based on the similarity threshold, similar dimensions as compared with the dimensions of the body part according to the sizing information provided by the three-dimensional model of the body part.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components.

FIG. 2 illustrates a diagram associated with an exemplary server component of the system illustrated in FIG. 1.

FIG. 3 illustrates an exemplary flow diagram of a process that enables an individual to download and install a software application, and subsequently access, or register to use, the software application for interaction with the system illustrated in FIG. 1.

FIG. 4 illustrates an exemplary flow diagram of a process that enables the individual of FIG. 3 to utilize a mobile or fixed image capture facility operable to capture a series of optical images of a body part of the individual for the purpose of generating a digital three-dimensional model of the body part.

FIG. 5 illustrates an exemplary flow diagram of a process that enables the individual to utilize a searching facility to identify one or more clothing, footwear or headgear items of interest that include similar detailed dimensions as compared with those captured during the process shown in FIG. 4.

FIG. 6 illustrates an exemplary flow diagram of a process that enables a retailer to access the software application for the purpose of offering clothing, footwear and headgear items for purchase and integrating their online store with functionality provided by the software application.

### DETAILED DESCRIPTION OF EMBODIMENT(S) OF THE INVENTION

For illustrative purposes, the present disclosure is described by referring to embodiment(s) thereof. In the following description, numerous specific details are set forth to provide a better understanding of the present disclosure. It will be readily apparent, that the current disclosure may be practiced without limitation to the specific details described in respect of the one or more embodiments. In other instances, some methods and structures have not been described in detail to avoid obscuring the present disclosure.

The present invention relates to at least a computer-implemented system and method for facilitating the purchase of items in an online environment. In an embodiment, the system and method provide a platform that hosts a computer executable software application (50) wherein the application (50) is accessible by individuals (30) who utilize the platform and its functionality to purchase or assist with purchasing items in an online environment. In particular, the system utilizes a central server (20) in communication with a data communication device (40) associated with each individual (30).

It is to be understood that reference to a “body part” (55) herein is not intended to be limited to a single body part of an individual, but may include a single body part, a combination of body parts, a region of the body, or the entire body of the individual.

It will be further appreciated that general reference to “individual” (30) herein is intended to reference users who access the software application (50) for the purpose of obtaining assistance with respect to purchasing items, as well as users associated with retail establishments who prefer to list wearable items for purchase and utilize the functionality of the software application (50) in integration with their own systems.

The central server (20) maintains one or more processors and/or databases for performing functions, including obtaining multiple optical images (60) of a body part (55) associated with the individual (30), the optical images (60) obtained using a mobile (180) or fixed (190) image capture facility, and subsequently resolving, by an optical resolution technique, the images (60) to generate a three-dimensional model (225) of the body part (55) along with relative and/or absolute sizing information regarding the three-dimensional model (225) of the body part (55). The central server (20) receives input data from one or more retailers offering items for purchase, including detailed dimensions of the items, and stores the input data as well as physical dimensions of the body part (55) as determined from the three dimensional model. In this way, a searching facility (240) may be provided which enables the individual (30) to search for and identify one or more wearable items of interest in the range of wearable items offered for purchase that include similar detailed dimensions as compared with the physical dimensions of the individual's body part (55) according to the three-dimensional model (225) of the body part (55). The search facility enables a listing of the one or more wearable items of interest that include similar detailed dimensions to be generated and provided to the individual (30) via software application (50) (e.g. for display upon a graphical user interface thereof).

The skilled person will appreciate that the platform provides a means by which individuals may purchase items in an online environment more efficiently by improving the accuracy of selecting a size for the particular item (e.g. the size of a particular item of clothing, footwear or headgear) resulting in a satisfying retail experience. The platform already knows the individual's size since the physical dimensions of the individuals body part (55) has already been determined from the generated three-dimensional model (225) and stored. Therefore, when the individual is browsing wearable items of interest using the software application (50), or an online store associated with a particular retailer in which such functionality is integrated, the search results presented to the individual (30) ensure that only products of an appropriate size are displayed for selection. The individual (30) is therefore assisted in relation to identifying a “perfect fit”, the first time, without the need to extensively search for or receive items amongst options that are not a correct fit, which enhances consumer confidence and satisfaction, whilst minimizing the likelihood of returns of items to retailers (thereby maximizing profits for the retailer).

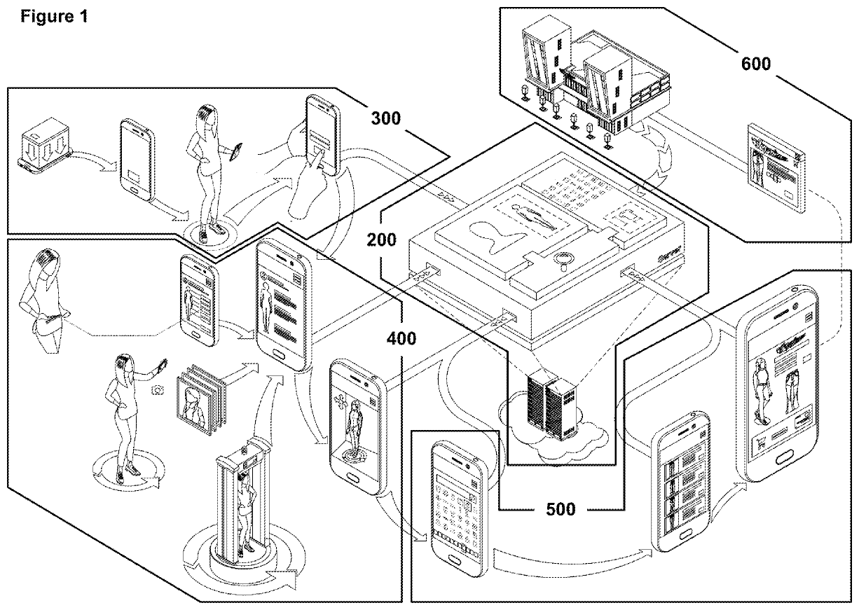

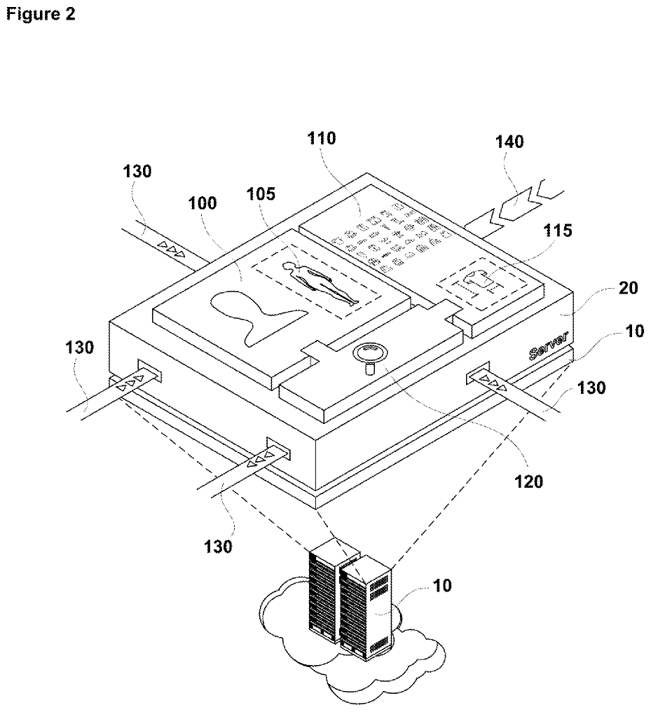

FIG. 1 is divided into segments which are further expanded in subsequent FIGS. 2-6. In particular, Segment 200 of FIG. 1 shows the server component (20) with which the software application (50) operating on data communication device (40) is configured to communicate. It will be apparent to the skilled person that the software application (50) may be a mobile application or a Web application and that, similarly, the data communication device (40) utilized by individual (30) may be a mobile device or computer device (e.g. mobile phone, tablet, laptop, personal computer, etc, operable to execute software application (50) and provide user interfaces for display to individual (30)). The server component (20) is additionally detailed in FIG. 2, and the skilled person will also appreciate that the steps described herein, as executed by the device, (40) may be facilitated by the software application (50) operating on the device.

As an alternative, or in addition to, steps described herein as performed by the server (20), the steps described may be performed by one or more processors associated with the user device (40) (i.e. in a distributed architecture). Different arrangements are possible in this regard, but according to a particular implementation of the present invention, the server (20) may be programmed to provide all of the functions described herein where they cannot be provided locally on the user device (40) or where it may be commercially infeasible.

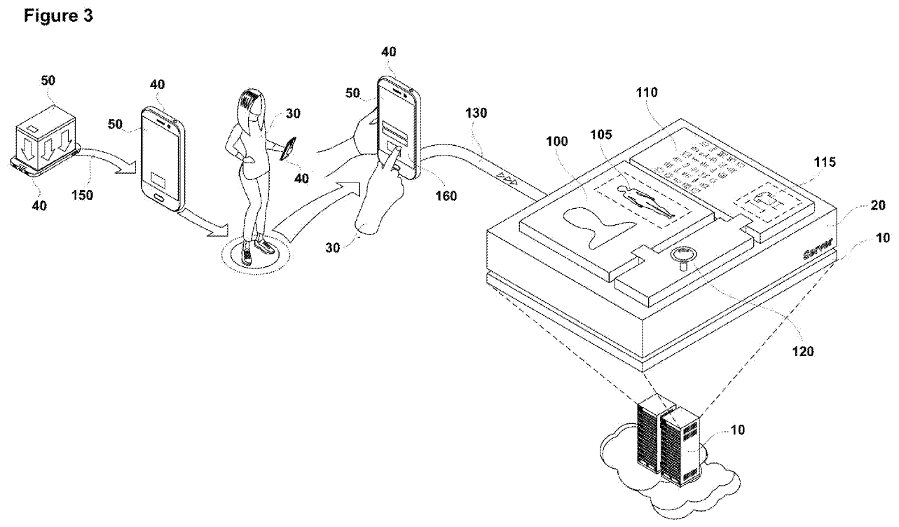

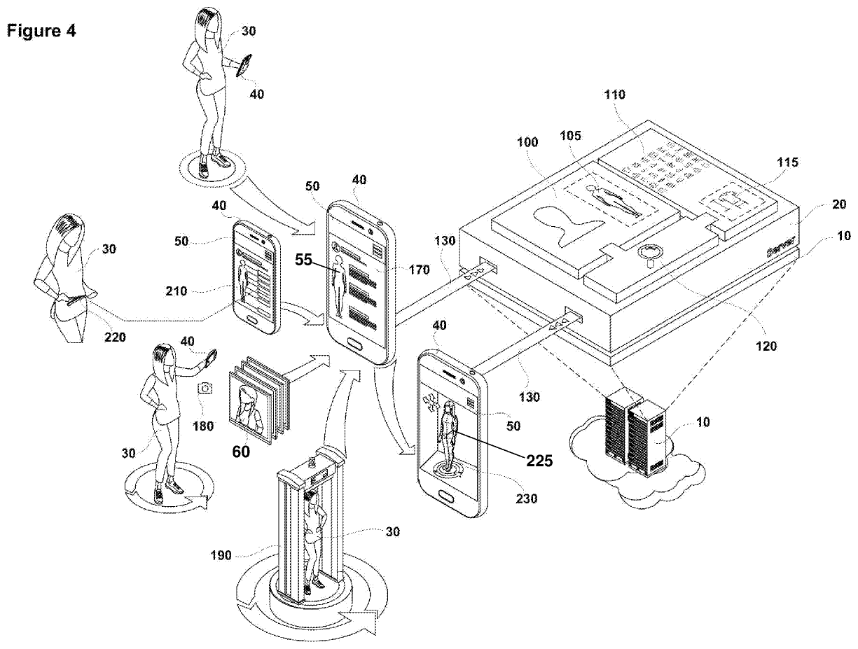

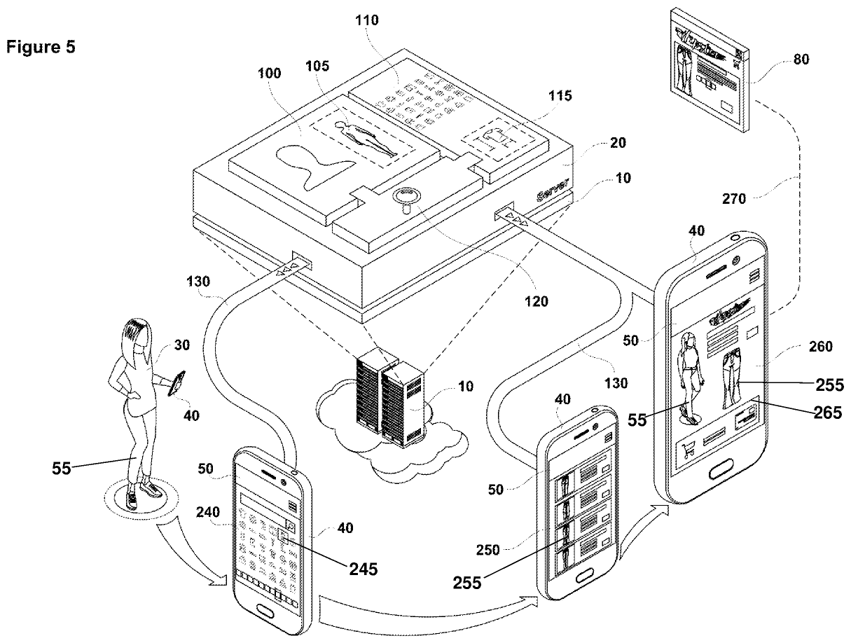

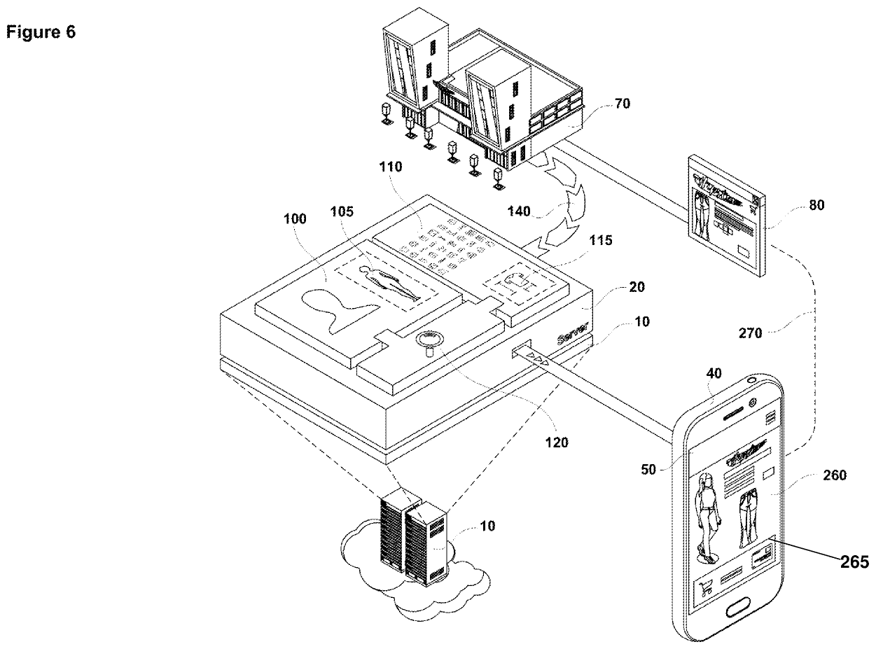

Segment 300 of FIG. 1 shows the individual (30) downloading and installing the application (50) and subsequently accessing the application (50) in order to establish an account, as further detailed in FIG. 3. Segment 400 of FIG. 1 illustrates how individual (30) may establish a user profile as shown in interface (170) as well as capture their detailed physical dimensions utilizing a variety of mechanisms, as further detailed in FIG. 4. Segment 500 of FIG. 1 illustrates how the individual (30) may conduct a search for and purchase items (e.g. clothing, footwear or headgear) that represent a fit for the individual (30) based upon their captured and stored physical dimensions, as detailed in FIG. 5. Finally, Segment 600 of FIG. 1 illustrates how the system and method of the present disclosure may integrate with an online retail store (80), as detailed in FIG. 6.

As mentioned above, FIG. 2 shows in greater detail Segment 200 of FIG. 1 and, in particular, the server component (20) which includes infrastructure (10) upon which the platform of the present invention operates. The infrastructure (10) may be local or cloud-based. The central server (20) may operate one or more computer processors and maintain one or more databases to enable the following functionality and/or storage:
User account register (100) storing details associated with individuals (30) registered to use the software application (50), such as name, age, address, contact details, and any additional data which may be relevant for the purpose of identifying the individual (30);
User profile register (105) storing details pertaining to created user profiles, including any captured optical images (60), physical dimensions of body parts (55) associated with the registered individual (30), and data relating to any models (225) which have been created based upon the received data (e.g. a two-dimensional or three-dimensional model of the individual's body part (55), as described in greater detail below);
Item catalogue (110) which is a register of the items that retailers have offered for purchase and which may be searched by individuals (30) using the software application (50);
Item data register (115) storing the input data associated with each of the items in item catalogue (110) including the detailed dimensions of the items, as well as any additional attributes pertinent to each item including item name, stock, category, colour, brand, style, material(s) and price, where such data may also be utilized to filter search results when individuals (30) utilize the searching facility (240); and
Searching facility functionality (120) being a search engine capable of identifying one or more items in the plurality of stored items that include similar detailed dimensions as compared with the physical dimensions of body part(s) of particular individuals (30) as determined from the three-dimensional models (225), including the ability to filter search results based upon item attributes such as those stored in register (115).

FIG. 2 also depicts that server (20) is configured to enable communication (130) with the user device (40) and, in particular, the software application (50) operating on the user device (40), as well as communication (140) with systems associated with item retailers (70). Such communications may occur via the internet or similar network.

FIG. 3 shows in greater detail Segment 300 of FIG. 1 and, in particular, the steps associated with the individual (30) installing the application (50), which may be achieved by downloading the application (50) from an application store. A similar process may apply to any additional user associated with, for example, item retailer (70) seeking to install/use the application (50) for the purpose of uploading input data relating to items the retailer prefers to offer for purchase. The individual (30) may create an account using the application (50) and the account information may be stored in the user account register (100), and as described above. The user account register (100) may capture information sufficient to enable each individual (30) to be correctly identified, and such details may also be validated against data stored in one or more public and/or private databases.

The process of installing the application (50) is indicated by arrow (150), and interface (160) is also shown which allows each individual (30) to download and install the application (50) in order to access the functionality thereof, including to create and maintain a user profile as shown in interface (170) in FIG. 4. In other words, once the application (50) has been accessed by an individual (30), the individual (30) may be presented with an interface, identical, or similar to, interface (170) to allow the individual (30) to create and maintain a user profile, including providing the individual (30) with the ability to add/edit details and access functionality of the application including to search for items of interest for purchase. Upon uploading sufficient information, the user (30) will be successfully registered such that the individual (30) becomes a registered user who may then utilize the full functionality of application (50).

As mentioned above, FIG. 4 shows in greater details segment 400 of FIG. 1, and in particular, the use of the application (50) by individual (30) to establish a profile as shown in interface (170). Obtaining multiple optical images of a body part (55) of the individual (30) may include utilizing an image capture component associated with the mobile user device (40), such as camera (180), or any other available hardware such as a fixed image capture component, e.g. commercial image capturing hardware (190) located at a retailer premises and capable of obtaining the multiple optical images (60). The image capture facility associated with software application (50) may integrate with such hardware in order to enable the software application to capture and store the optical images (60).

As shown in FIG. 4, where an image capture device such as camera (180) is used, multiple optical images (60) may be captured of the body part (55) of the individual (30) from a range of different angles by capturing a series of images as the camera lens is passed over the body part (55) (e.g. by taking multiple “selfies” from different angles). Alternatively, the individual (30) may request assistance from another individual to capture the series of images using device (50).

The determination of dimensions (sizing information) associated with features of the three-dimensional model (225) may be absolute or relative. For example, an absolute measurement may use absolute dimension values that are not based on the size of something else. In the example of relative dimensions, the images (60) may capture the body part (55) along with another object (not shown) of known dimensions that is also within view of the camera (180). For example, the object may be attached, or located in proximity with, the body part (55) such that resolution of the images (60) to generate a three-dimensional model (225) of the body part (55) may include a comparison of body part images (60) with the object of known dimensions (not shown).

The use of an optical image capture device to obtain a series of optical images and generate a three-dimensional model of an object therefrom as known in respect of health services generally and dental services in particular wherein optical images are utilised to generate three dimensional model of teeth that require a crown or other dental augmentation requiring an accurately dimensioned model of the existing dental environment.

Further, the software application (50) executing on the individual's device (50) may provide guidance regarding adequate capture of body part images and may provide prompts, both audibly and/or visually, to guide the user (30) or another individual assisting the user (30), when passing the device camera (180) over body parts (55). For example, the guidance may relate to when sufficient images (60) have been attained to enable the system to generate a three-dimensional model (225) of the body part (55) with sufficient data to determine the dimensions of features in the model (225).

As shown in interface (210), in addition to generating the three-dimensional model (225) and thereby determining the physical dimensions of the body part (55) based upon the received multiple optical images (60), one or more dimensions may be determined based upon data that is input manually by the individual (30), e.g. data that is input into application (50) by the individual (30) based upon physically measuring (220) their own body dimensions using a tape measure or similar measuring device. Such manual entry of physical dimensions may not necessarily be required, and it is envisaged that this will only be required when one or more physical dimensions are unable to be resolved from the three-dimensional model (225).

In order to satisfy privacy regulations that are applicable, it may be necessary for the application (50) to delete any received optical image(s) (60) of the individual (30). In this regard, the application (50) may be programmed to automatically delete any received optical images (60) once relevant physical dimensions have been determined from the three-dimensional model (225). The software application (50) may also be operable to prompt the individual (30) to provide updated image data (e.g. updated optical images) of the individual's body part (55) at regular intervals for the purpose of ensuring that the stored physical dimensions of the body part(s) are recently captured and hence substantially representative of the current physical dimensions of the body part (55). The skilled addressee will appreciate that the weight of the individual (30) may fluctuate and it may therefore be preferable to ensure that data relating to the physical dimensions of the individual (30) is captured frequently.

As previously mentioned, the software application (50) may be operable to create and display a three-dimensional model (225) of the body part (55) of the individual (30) based upon resolution of the images (60), as shown in interface (230) of FIG. 4. Whilst not shown, the physical dimensions of the body part of the individual (30) as determined from the three-dimensional model (225) may also be displayed in interface (230) (e.g. in a dimensions table that may be subsequently updated/edited). The interface (230) may allow a user (30) to manipulate the image to better view certain body parts or regions, e.g. rotate, zoom in, zoom out, etc. The skilled addressee will appreciate that the three-dimensional model (225) will enable the individual (30) to visualize the relative shape and size of their body part(s) (55). As described in greater detail below, such a model (225) will also enable the individual (30) to visualize what an item will look like when worn, used or carried by the model depicted in interface (230).

FIG. 5 shows in greater detail segment 500 of FIG. 1 and, in particular, the process involving individual (30) utilizing the searching facility of application (50) as shown according to a particular embodiment in interface (240).

As previously described, the searching facility ensures that only those items of interest that include similar detailed dimensions (according to a similarity threshold) as compared with the physical dimensions of the body part of the individual (30) are identified and provided in a search result listing (or similar display) presented to the individual (30). This ensures that only those items which are likely to represent a fit for the individual (30) are displayed. The similarity threshold may be predefined, and the threshold may well be different for different body parts and/or items available for purchase. For example, an important measurement for men's shirts is the neck region to ensure that the shirt does not fit too tight around the user's neck. The similarity threshold may be defined such that a higher level of similarity is required in relation to the dimensions of the user's neck region as compared with the collar region of the shirt, as opposed to another region of body part/shirt such as the chest region for example where a close fit may not be considered to be as important. The software application (50) may provide default similarity thresholds, but may also provide a facility that enables users (30) to revise the thresholds according to their requirements and/or preferences.

The skilled addressee will appreciate that by locating and displaying only a subset of all of the available stored items based upon the determined physical dimensions of the body part (55), as compared with all of the stored items (which may total hundreds or thousands of items), for selection by the individual (30) will conserve processor and memory resources of the device (40) as well as the server (20).

The searching facility may enable the individual to select a particular wearable item of interest through a keyword search. For example, the individual (30) may be a female interested in purchasing a new dress. The individual (30) may enter into the search engine a keyword relating to the name of the item, i.e. “dress”, and based upon such input, a list of applicable items (i.e. a list of available dresses which correspond with the physical dimensions of the individual (30) will be generated). The search results may be further filtered by one or more additional attributes of the item including, for example, a brand name associated with the dress, a location or geographical area in which the dress is available for purchase (e.g. within a particular geographical vicinity of the individual (30)), a retailer name, a price of the dress, a visual attribute of the dress (e.g. colour, style, etc.) and a physical attribute of the dress (e.g. the dress material).

In an alternative embodiment, and as shown in interface (240) of FIG. 5, the search facility may display a range of items (or item categories), e.g. items or item categories that are determined as potentially interesting to the user (30), e.g. based upon past searches, user preferences, etc. When viewing such an interface, the individual (30) may observe and select a particular item or item category of interest, e.g. trousers (245). Interface (250) in FIG. 5 provides an example of a search listing after the individual has selected the graphical illustration of “trousers” (245) from the item selection interface (240). As shown in interface (250), there is a list of available trousers offered for purchase by one or more retailers, and it will be appreciated that all trousers in this listing will automatically be an appropriate size and fit for the individual (30) since the particular trousers listed were selected based upon similarities between the detailed dimensions of the trousers as compared with the physical dimensions determined in respect of the relevant body part (55) submitted by individual (30) (e.g. in this example, the waist and leg dimensions of the individual (30)).

In other words, the listing of trousers shown in interface (250) is limited to only those trousers that include similar detailed dimensions as compared with the relevant physical dimensions of the individual (30) as determined from the three-dimensional model (225), hence there is no further requirement for the individual (30) to review and filter results in an effort to ensure that items listed will be appropriately sized.

In the event that there are no results in the listing shown in interface (250), e.g. on the basis that there are no items located which have similar detailed dimensions as compared with the physical dimensions determined in respect of the individual's body part (55), the individual (30) may be prompted in interface (250) to broaden their search so that the listing includes items which correspond to, for example, the next closest size to that which is considered to correspond with the individual's physical dimensions. The increased scope of the search may include other countries beyond the country in which the user is located/domiciled.

When a particular item from interface (250) is selected by the individual (30), one or more additional interfaces may be automatically generated, such as interface (260) that provides additional information relating to the selected item (255). The selection of a particular item (255) may further cause the software application (50) to perform one or more additional actions, including generating the three-dimensional model (225) of the relevant body part (55) of the individual (30), and generating a graphical representation of the selected item (255) fitted over the relevant body part (55).

As shown in FIG. 5, the interface (260) may further include a prompt (265) that, when selected, enables the individual (30) to purchase the selected item (255) without navigating away from the software application (50). Alternatively, as shown in FIG. 6, the selection of the prompt (265) may automatically operate (270) a web browser to display a web page associated with a retailer (70) (e.g. a home page or the product purchase page), thereby also enabling purchase of the item via the retailer's online store (80).

It is to be understood that the item retailers (70) may also access the software application (50) for the purpose of uploading and managing details relating to the items offered for purchase by the retailer. Accordingly, the application (50) that is made available to retailers may include alternate functionality as compared with the application that is made available to consumers. The data that is input by retailers will include detailed dimensions of the item in each of the retailer's available sizes, and may include additional details such as a description of the item, an image of the item, item stock and relevant links to the retailer website and/or online store (80). According to a particular implementation, the stored input data relating to each item will automatically synchronize with one or more systems (e.g. one or more databases) associated with the retailer (70) to ensure that the stored input data is maintained up to date, which may be particularly important to ensure that the stock levels of each item are maintained up to date in application (50).

According to another implementation, functionality associated with the software application (50) may be integrated into the retailer's online store (80) using, for example, an application programming interface (API). In this way, when an individual (30) accesses the online store (80) and views and/or searches for items of interest, the searching facility associated with application (50) causes only those items of interest that include similar detailed dimensions as compared with the physical dimensions of the relevant body part of the individual (30) will be displayed and/or listed in search results presented by the online store (80).

As used herein, the term “central server”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

The claims defining the invention are as follows:

1. A computer-implemented system for facilitating the purchase of wearable items in an online environment, the system including:
an image capture facility operable to obtain multiple optical images of a body part of an individual and resolving, by an optical resolution technique, the images to generate a three-dimensional model of the body part, wherein the resolving of optical images to generate the three-dimensional model further provides relative and/or absolute sizing information regarding the three-dimensional model of the body part;
one or more processors operable to receive input data from one or more retailers offering a range of wearable items for purchase, the input data including detailed dimensions of the wearable items;
one or more databases in communication with the one or more processors,
the one or more databases configured to store the physical dimensions of the body part, as determined from the three-dimensional model, the input data including the detailed dimensions of the wearable items;
a searching facility configured to identify one or more wearable items of interest in the range of items offered for purchase that include detailed dimensions similar to those dimensions of the body part as determined from the three dimensional model, according to a similarity threshold;
the one or more processors further operable to:
generate and provide a display of the one or more wearable items of interest that include similar detailed dimensions as compared with the physical dimensions of the body part according to the three-dimensional model of the body part.

2. A system according to claim 1, wherein the searching facility is operable by an individual utilizing a software application operable on a data communications device.

3. A system according to either claim 1 or claim 2, wherein the body part of the individual is a body part, a combination of body parts, a body region or regions, or an entire body of the individual.

4. A system according to any one of the preceding claims, wherein obtaining optical images of the body part of the individual includes utilizing an optical hardware component associated with a mobile data communications device, including passing an optical lens associated with the optical hardware component over the body part.

5. A system according to any one of claims 1 to 3, wherein obtaining optical images of the body part of the individual includes utilizing fixed body image capture hardware associated with a retailer which is configured to capture the multiple optical images.

6. A system according to either claim 4 or claim 5, wherein the optical images of the body part are captured from a range of different angles to enable generation of the three-dimensional model.

7. A system according to claim 6, wherein the images of the body part are captured along with an object of known dimensions that is within view of the optical lens and attached, or located in proximity with, the body part such that resolution of the images to generate the three dimensional model includes comparison of body part images with the object of known dimensions to determine the dimensions of the three dimensional model.

8. A system according to any one of claims 4 to 7, wherein the one or more operations further include providing guidance regarding adequate capture of body part images, and audible and/or visual prompts to guide the individual when capturing images including when they have attained sufficient images to enable generation of the three-dimensional model of the body part with sufficient data to determine the dimensions of features in the model.

9. A system according to any one of the preceding claims, wherein the resolution of the images to determine the three-dimensional model is assisted by data input by the individual, including data manually entered by the individual in relation to one or more physical dimensions of the body part unable to be determined from the resolution of images and generation of the model.

10. A system according to any one of the preceding claims, wherein the one or more processors are further operable to generate a display of the physical dimensions and/or the three-dimensional model of the body part.

11. A system according to any one of the preceding claims, wherein the generated display of the one or more wearable items of interest that include similar detailed dimensions as compared with the physical dimensions of the body part includes a scrollable listing of items.

12. A system according to any one of the preceding claims, wherein the one or more processors are further operable to delete any received optical image(s) once the physical dimensions of the body part have been determined from the three-dimensional model.

13. A system according to any one of the preceding claims, wherein the one or more processors are further operable to generate a prompt to the individual to provide an updated series of optical images of the body part for the purpose of ensuring that the stored physical dimensions of the body part are accurate and representative of current physical dimensions of the body part.

14. A system according to any one of the preceding claims, wherein the searching facility enables the individual to filter the displayed one or more wearable items of interest, according to one or more of:
a name of the item,
a category of the item,
a brand name associated with the item,
a location or geographical zone,
a retailer of the item,
a price of the item,
a visual attribute of the item, or
a physical attribute of the item.

15. A system according to any one of the preceding claims, wherein the display of the one or more wearable items of interest is limited to only those items that include similar detailed dimensions as compared with the physical dimensions of the body part according to the similarity threshold, hence avoiding further requirement for the individual to review and filter results to ensure that the displayed wearable items represent a substantially correct and/or preferred fit.

16. A system according to claim 15, wherein the similarity threshold is selected according to the particular body part and/or item under comparison.

17. A system according to any one of the preceding claims, wherein, in the event there are no results in the display of the one or more wearable items of interest on the basis that there are no items located having similar detailed dimensions as compared with the physical dimensions of the body part according to the similarity threshold, the one or more processors are further operable to generate a prompt to the individual to broaden their search such that the listing includes items of the nearest dimensions.

18. A system according to any one of the preceding claims, wherein the wearable item is an item of clothing, footwear or headgear.

19. A system according to claim 18, wherein selection of a particular wearable item in the display of the one or more wearable items of interest causes the software application to perform an action including any one or more of:
generating one or more user interfaces providing additional information relating to the selected wearable item,
generating one or more user interfaces displaying the three-dimensional model of the body part including graphical representations of the selected wearable item worn by the three-dimensional model of the body part;
generating one or more user interfaces enabling purchase of the selected wearable item; or
operating a web browser to display a page associated with a retailer of the wearable item to thereby enable purchase of the wearable item from the retailer's online store.

20. A system according to any one of the preceding claims, wherein the one or more processors further enable retailers to upload and manage details relating to the wearable items that the retailer offers for purchase, the details including the detailed dimensions of the wearable item in each available size, and further including one or more of an image of the wearable item, item stock, or links to the retailer website and/or online store.

21. A system according to claim 20, wherein the stored input data relating to each wearable item regularly synchronizes with one or more computer systems associated with the retailer to ensure that the stored input data is maintained up to date.

22. A system according to either claim 20 or claim 21, wherein the one or more processors are further operable to integrate with the data of a retailer's online store using an application programming interface (API), such that when the individual accesses the online store and views and/or searches wearable items of interest, only those wearable items of interest that include similar detailed dimensions as compared with the physical dimensions of the body part of the individual will be displayed and/or listed in search results generated from the online store.

23. A computer-implemented method for facilitating the purchase of wearable items in an online environment, the method including:
obtaining, by one or more processors, multiple optical images of a body part of an individual and resolving, by an optical resolution technique, the images to generate a three-dimensional model of the body part, wherein the resolving of optical images to generate the three-dimensional model further provides relative and/or absolute sizing information regarding the three-dimensional model of the body part;
receiving, by one or more processors, input data from one or more retailers offering a range of wearable items for purchase, the input data including detailed dimensions of the wearable items;
storing, by one or more processors, the physical dimensions of the body part, as determined from the three-dimensional model, and the input data including the detailed dimensions of the wearable items;
searching for and identifying, by a searching facility, one or more wearable items of interest in the range of wearable items offered for purchase that include similar detailed dimensions as compared with the physical dimensions of the body part, according to a similarity threshold; and
generating and providing, by one or more processors, a display of the one or more wearable items of interest that include similar detailed dimensions as compared with the physical dimensions of the body part according to the three-dimensional model of the body part.

24. A computer-readable medium having a plurality of computer instructions executable by one or more processors, that, when executed, cause the one or more processors to perform the steps of:
obtain multiple optical images of a body part of an individual and resolving, by an optical resolution technique, the images to generate a three-dimensional model of the body part, wherein the resolving of optical images to generate the three-dimensional model provides relative and/or absolute sizing information regarding the three-dimensional model of the body part;
receive input data from one or more retailers offering a range of wearable items for purchase, the input data including detailed dimensions of the items;
store, in one or more databases, the physical dimensions of the body part, as determined from the three-dimensional model, the input data including the detailed dimensions of the wearable items;
search for and identify, by a searching facility, one or more wearable items of interest in the range of wearable items offered for purchase that include similar dimensions as compared with the physical dimensions of the body part, according to a similarity threshold, and
generating and providing a display of the one or more wearable items of interest that include similar dimensions as compared with the dimensions of the body part according to the three-dimensional model of the body part.
